(19) United States
(12) Patent Application Publication
(10) Pub. No.: US 2010/0061592 A1
(43) Pub. Date: Mar. 11, 2010

(54) SYSTEM AND METHOD FOR ANALYZING THE MOVEMENT AND STRUCTURE OF AN OBJECT

(76) Inventors: Christopher L. Hudson, Orlando, FL (US); Dominick Esposito, Corbin, NY (US)

Correspondence Address: EDWARD M. LIVINGSTON, PA, 963 TRAIL TERRACE DRIVE, NAPLES, FL, 34103, US

(21) Appl. No.: 12/205,139

(22) Filed: Sep. 5, 2008

(51) Int. Cl. G06K 9/00; G09G 5/00

(52) U.S. Cl. 382/103; 345/633

(57) ABSTRACT

A system and method for analyzing the movement and structure of an object (14) having a display for the object using an indicator point (9) located at the center of the object, a cube (2) having a reference point (10) located thereon, and superimposing the cube over said object wherein the object is placed within the cube wherein the indicator point is centered with the reference point on the cube and a means for analyzing movement and structure of said object to be analyzed. The movement and structure of the object is analyzed by creating reference lines (11), reference circles (12) and reference triangles (13) at predetermined angles and distances in relationship to the cube to create a geometric grid (1) which then may be used as a measuring and graphing tool.

### BACKGROUND OF THE INVENTION

This invention relates to systems and methods for analyzing the movement and structure of an object, more particularly, a system and method for analyzing the movement and structure of an object wherein the movement and structure of the object maybe analyzed without the use of external components connected to the object.

Currently there are many systems and methods on the market wherein the movement and structure of an object are analyzed for educational purposes. For example, electronic systems are commonly placed on an object, such as a human being, during the movement of said object so as to capture various points of movement in a three-dimensional field. The pinpoints, or data, are then transmitted to an analyzation system, typically a computer, to generate a three-dimensional image of the object. Ideal body movement of the object is then displayed on the analyzation system so as to indicate how the object should ideally move as opposed to how the object is currently moving. These types of analyzation systems and methods are commonly used when analyzing the swing of a golfer, baseball player, tennis player, etc.

Current analyzation systems utilize at least one component that is attached to the object being analyzed. It is often difficult to obtain a true and accurate depiction of the object's complete natural movement because of the placement, size and/or added weight of the component.

Additionally, when an object is analyzed using attached components it is most often done in a laboratory or other controlled environment wherein real-world elements, such as wind-speed, heat, cold, daylight and the like are not present.

Furthermore, most analyzation systems and methods are limited in analyzing only the surface area of an object, thereby converting the movement and imagery of the surface area into imagery for analyzation purposes. Although the data from the surface area of the object is an appropriate means for analyzing the movement of the object, the internal structure of the object is not calculated or taken into account.

Thus, a need exists for a system and method for analyzing the movement and structure of an object wherein both the external and internal movement and structure of the object may be analyzed without the use of external components connected to the object.

The relevant prior art includes the following references:

| Patent No. | | |
|---|---|---|
| (U.S. unless stated otherwise) | Inventor | Issue/Publication Date |
| 7,095,388 | Truxa et al. | Aug. 22, 2006 |
| 6,533,675 | Funk | Mar. 18, 2003 |
| 6,416,327 | Wittenbecher | Jul. 09, 2002 |
| 5,772,522 | Nesbit et al. | Jun. 30, 1998 |
| 5,823,878 | Welch | Oct. 20, 1998 |
| 5,184,295 | Mann | Feb. 02, 1993 |
| 4,137,566 | Haas et al. | Jan. 30, 1979 |
| 2005/0032582 | Mahajan et al. | Feb. 10, 2005 |

### SUMMARY OF THE INVENTION

The primary object of the present invention is to provide a system and method for analyzing the movement and structure of an object wherein both the external and internal movement and structure of the object may be analyzed without the use of external components connected to the object.

Another object of the present invention is to provide a system and method for analyzing the movement and structure of an object wherein an exact center of an object may be determined.

A further object of the present invention is to provide a system and method for analyzing the movement and structure of an object that provides feedback for indicating inefficiencies in the movement of the object.

An even further object of the present invention is to provide a system and method for analyzing the movement and structure of an object that provides feedback for indicating ideal movement of the object.

Another object of the present invention is to provide a system and method for analyzing the movement and structure of an object that permits a user to locate structurally deficient points in the object.

The present invention fulfills the above and other objects by providing a system for analyzing the movement and structure of an object having a means for displaying the object on a display, such as a computer monitor or television screen, wherein the object has at least one indicator point, at least one cube having at least one reference point located thereon, a means for superimposing the at least one cube over said object wherein the object is placed within the least one cube wherein the at least one indicator point on the object is centered with the at least one reference point on the at least one cube and a means for analyzing movement and structure of said object. The means for analyzing the movement and structure of the object is by creating reference lines, reference circles and reference triangles at predetermined angles and distances in relationship to the at least one cube to create a geometric grid which then may be used as a measuring and graphing tool to analyze an object at rest and/or an object in motion.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective front view of a cube of the present invention;

FIG. 2 is a front view of a geometric grid of the present invention;

FIG. 3 is a front view of an object placed inside of the geometric grid of the present invention superimposed on a golfer;

FIG. 4 is a front view of an alternative embodiment of a geometric grid of the present invention; and

FIG. 5 is a front view of an object placed inside of the alternative embodiment of a geometric grid of the present invention superimposed on a human skeleton.

### DESCRIPTION OF THE PREFERRED EMBODIMENTS

For purposes of describing the preferred embodiment, the terminology used in reference to the numbered components in the drawings is as follows:
1. geometric grid
2. cube
3. front face
4. back face
5. bottom face
6. top face
7. right side face
8. left side face
9. indicator point
10. reference point
11. reference lines
12. reference circle
13. reference triangle
14. object

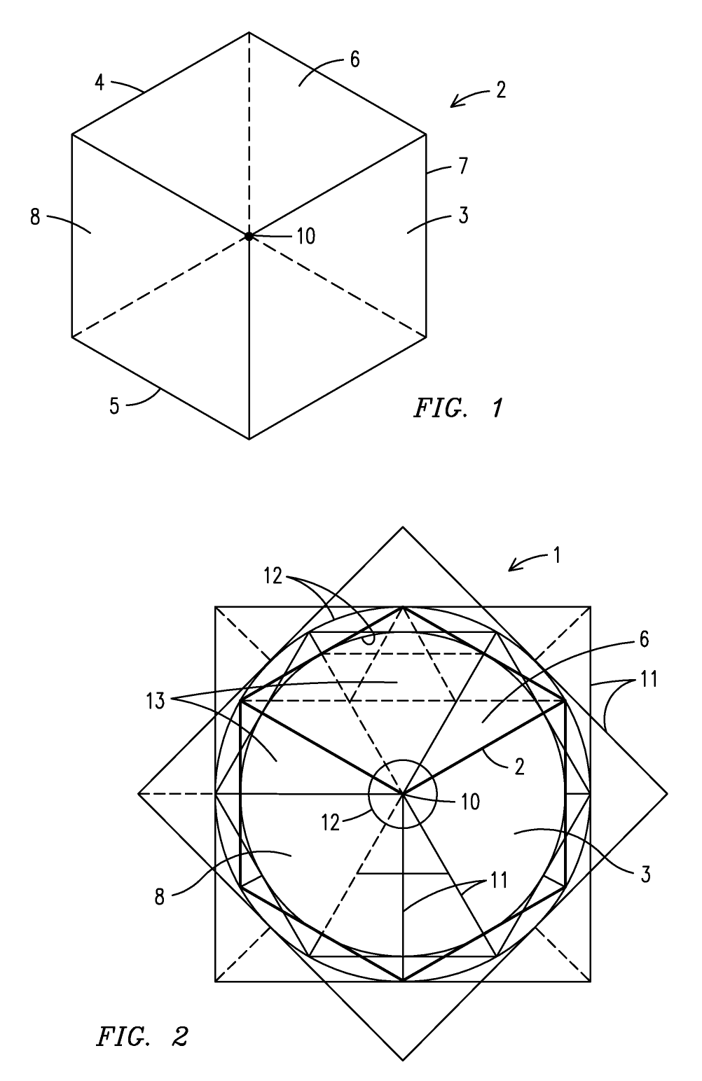

Referring to FIG. 1, a front view of a cube of the present invention is shown comprising a front face 3, a back face 4, a bottom face 5, a top face 6, a right side face 7 and a left side face 8. The cube 2 is rotated approximately thirty degrees for placement of an object to account for movement of any object 14 in relation to its center, as shown and described below. An additional reason for the placement of the cube is to put the top corner of the cube 2 where the front face 3, top face 6 and right side face 7 all meet in line with the central axis of the cube. This point is the reference point 10. The cube 2 is the basis for all geometric grids 1 used to analyze movement and structure in the present invention.

Referring now to FIG. 2, a geometric grid 1 of the present invention is shown. The geometric grid 1 is made by first placing the cube 2 so that the reference point 10 will be at the center of the geometric grid 1. Reference lines 11, reference circles 12 and reference triangles 13 are then placed at different places in and around the cube 2. The placement of the reference lines 11, reference circles 12 and reference triangles 13 depends on what is being analyzed.

As shown in FIG. 3, an object 14 has been place inside of the geometric grid 1 from FIG. 2. The object 14 is a golfer swinging a golf club. The geometric grid 1 has been superimposed over the object 14 so that the object 14 is centered within the cube 2. The center of the object 14 or the indicator point 9 is lined up with the reference point 10 to insure that the object 14 is centered within the geometric grid 1. The reference triangles 13 may be used to analyze the placement and movement of the object's 14 legs. The reference circles 12 may be used to analyze the object's 14 swing as the golf club relates to the object's 14 body. The reference lines 11 may be used to analyze the positioning of the object's 14 shoulders and hips.

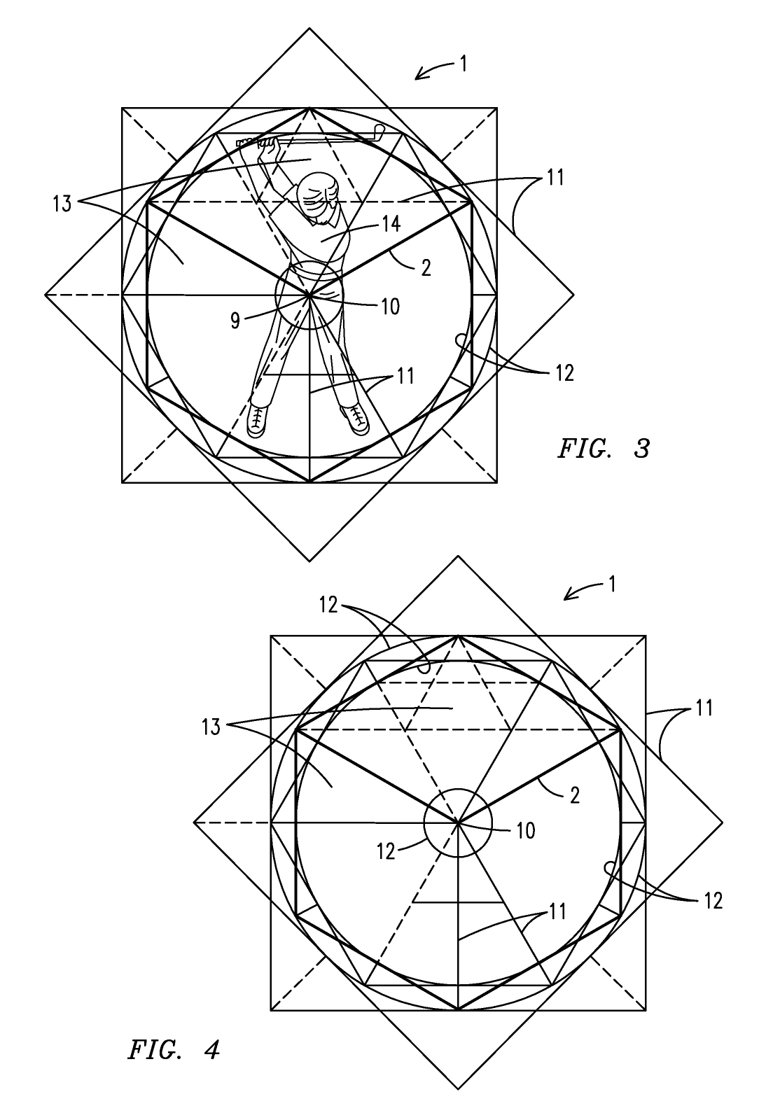

Referring now to FIG. 4, an alternative embodiment of the geometric grid is shown. The geometric grid 1 is made by first placing the cube 2 so that the reference point 10 will be at the center of the geometric grid 1. Reference lines 11, reference circles 12 and reference triangles 13 are then placed at different places in and around the cube 2. The placement of the reference lines 11, reference circles 12 and reference triangles 13 depends on what is being analyzed.

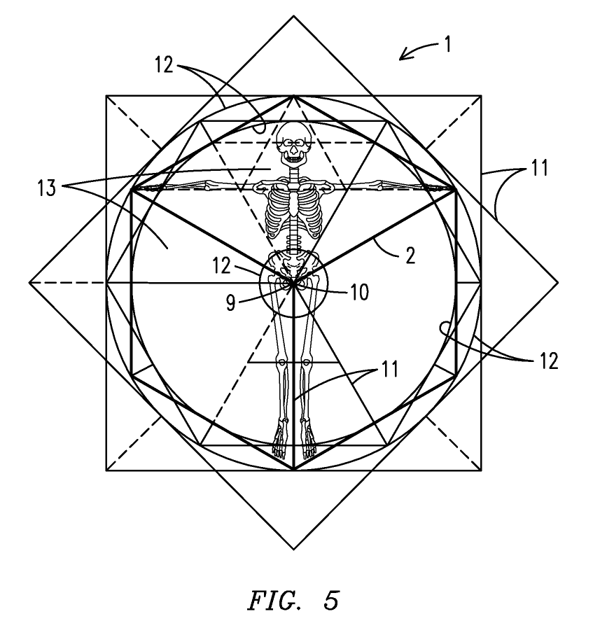

As shown in FIG. 5, an object 14 has been placed inside of the geometric grid 1 from FIG. 4. The object 14 is a human skeleton. The geometric grid 1 has been superimposed over the object 14 so that the object 14 is centered within the cube 2. The indicator point 9 is centered with the reference point 10 to insure that the object 14 is centered within the geometric grid 1. The reference triangles 13 may be used to analyze the rotational movement of the object 14. The reference circles 12 may be used to analyze the horizontal and lateral movement of the object 14 during movement. The reference lines 11 maybe used to analyze the positioning of the object 14 during movement.

The invention may be used with a computer to allow the user to take pictures or video of the object 14 and display those pictures and videos an a computer monitor. The user may then use the computer to create a customized geometric grid 1 based off the cube 2 shown in FIG. 1. The user may then superimpose the geometric grid 1 over the object 14 so that the object is centered inside of the geometric grid 1. The user may then plot, measure and compare any point of the object 14 in relation to other points of the object 14 using the computer and the geometric grid 1. For example, referring to FIG. 3, the user may plot the placement of a golfer's legs in comparison to a golfer's shoulders at any point during a golf swing. In addition, a user may store measurements in a database for comparisons to future measurements. The user may use comparisons between current measurements and past measurements stored in the database to analyze and diagnose weaknesses and strengths in an object's movement and structure.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A system for analyzing the movement and structure of an object comprising:
a means for providing an object on a display;
said object having at least one indicator point;
at least one cube having at least one reference point located thereon;
a means for superimposing said at least one cube over at least a portion of said object wherein said object is substantially centered within said at least one cube; and
a means for analyzing movement and structure of said object wherein said at least one said indicator point on said object is centered to said at least one reference point on said at least one cube.

2. The system for analyzing the movement and structure of an object of claim 1 wherein:
said at least one cube is rotated approximately thirty degrees in relation to said object.

3. The system for analyzing the movement and structure of an object of claim 1 wherein:
said means for providing an object on a display is in real-time.

4. The system for analyzing the movement and structure of an object of claim 1 wherein:
said means for providing an object on a display is delayed.

5. The system for analyzing the movement and structure of an object of claim 2 wherein:
said means for providing an object on a display is in real-time.

6. The system for analyzing the movement and structure of an object of claim 2 wherein:
said means for providing an object on a display is delayed.

7. The system for analyzing the movement and structure of an object of claim 1 wherein said means for analyzing the movement and structure of said object comprises:
measuring at least one angle formed between said at least one indicator point intersecting with said at least one reference point and/or at least one face of said cube and superimposing a reference line over said cube according to a predetermined ideal position.

8. The system for analyzing the movement and structure of an object of claim 2 wherein said means for analyzing the movement and structure of said object comprises:
measuring at least one angle formed between said at least one indicator point intersecting with said at least one reference point and/or at least one face of said cube and superimposing a reference line over said cube according to a predetermined ideal position.

9. The system for analyzing the movement and structure of an object of claim 3 wherein said means for analyzing the movement and structure of said object comprises:
measuring at least one angle formed between said at least one indicator point intersecting with said at least one reference point and/or at least one face of said cube and superimposing a reference line over said cube according to a predetermined ideal position.

10. The system for analyzing the movement and structure of an object of claim wherein said means for analyzing the movement and structure of said object comprises:
measuring at least one angle formed between said at least one indicator point intersecting with said at least one reference point and/or at least one face of said cube and superimposing a reference line over said cube according to a predetermined ideal position.

11. The system for analyzing the movement and structure of an object of claim 5 wherein said means for analyzing the movement and structure of said object comprises:
measuring at least one angle formed between said at least one indicator point intersecting with said at least one reference point and/or at least one face of said cube and superimposing a reference line over said cube according to a predetermined ideal position.

12. The system for analyzing the movement and structure of an object of claim 6 wherein said means for analyzing the movement and structure of said object comprises:
measuring at least one angle formed between said at least one indicator point intersecting with said at least one reference point and/or at least one face of said cube and superimposing a reference line over said cube according to a predetermined ideal position.

13. The system for analyzing the movement and structure of an object of claim 1 wherein said means for analyzing the movement and structure of said object comprises:
measuring a predetermined distance from said at least one indicator point intersecting with said at least one reference point and/or at least one face of said cube and superimposing a reference circle over said cube wherein the predetermined distance is the radius of said reference circle.

14. The system for analyzing the movement and structure of an object of claim 2 wherein said means for analyzing the movement and structure of said object comprises:
measuring a predetermined distance from said at least one indicator point intersecting with said at least one reference point and/or at least one face of said cube and superimposing a reference circle over said cube wherein the predetermined distance is the radius of said reference circle.

15. The system for analyzing the movement and structure of an object of claim 3 wherein said means for analyzing the movement and structure of said object comprises:
measuring a predetermined distance from said at least one indicator point intersecting with said at least one reference point and/or at least one face of said cube and superimposing a reference circle over said cube wherein the predetermined distance is the radius of said reference circle.

16. The system for analyzing the movement and structure of an object of claim 4 wherein said means for analyzing the movement and structure of said object comprises:
measuring a predetermined distance from said at least one indicator point intersecting with said at least one reference point and/or at least one face of said cube and superimposing a reference circle over said cube wherein the predetermined distance is the radius of said reference circle.

17. The system for analyzing the movement and structure of an object of claim 5 wherein said means for analyzing the movement and structure of said object comprises:
measuring a predetermined distance from said at least one indicator point intersecting with said at least one reference point and/or at least one face of said cube and superimposing a reference circle over said cube wherein the predetermined distance is the radius of said reference circle.

18. The system for analyzing the movement and structure of an object of claim 6 wherein said means for analyzing the movement and structure of said object comprises:
measuring a predetermined distance from said at least one indicator point intersecting with said at least one reference point and/or at least one face of said cube and superimposing a reference circle over said cube wherein the predetermined distance is the radius of said reference circle.

19. The system for analyzing the movement and structure of an object of claim 1 wherein said means for analyzing the movement and structure of said object comprises:
measuring a predetermined distance from said at least one indicator point intersecting with said at least one reference point and/or at least one face of said cube and superimposing a reference triangle over said cube.

20. The system for analyzing the movement and structure of an object of claim 2 wherein said means for analyzing the movement and structure of said object comprises:
measuring a predetermined distance from said at least one indicator point intersecting with said at least one reference point and/or at least one face of said cube and superimposing a reference triangle over said cube.

21. The system for analyzing the movement and structure of an object of claim 3 wherein said means for analyzing the movement and structure of said object comprises:
measuring a predetermined distance from said at least one indicator point intersecting with said at least one reference point and/or at least one face of said cube and superimposing a reference triangle over said cube.

22. The system for analyzing the movement and structure of an object of claim 4 wherein said means for analyzing the movement and structure of said object comprises:
measuring a predetermined distance from said at least one indicator point intersecting with said at least one reference point and/or at least one face of said cube and superimposing a reference triangle over said cube.

23. The system for analyzing the movement and structure of an object of claim 5 wherein said means for analyzing the movement and structure of said object comprises:
measuring a predetermined distance from said at least one indicator point intersecting with said at least one reference point and/or at least one face of said cube and superimposing a reference triangle over said cube.

24. The system for analyzing the movement and structure of an object of claim 6 wherein said means for analyzing the movement and structure of said object comprises:
measuring a predetermined distance from said at least one indicator point intersecting with said at least one reference point and/or at least one face of said cube and superimposing a reference triangle over said cube.

25. The system for analyzing the movement and structure of an object of claim 1 further comprising:
a means for locating an exact center of said object.

26. The system for analyzing the movement and structure of an object of claim 2 further comprising:
a means for locating an exact center of said object.

27. The system for analyzing the movement and structure of an object of claim 25 wherein said means for locating an exact center of said object comprises:
superimposing a plurality of increasingly smaller concentric cubes within said at least one cube.

28. The system for analyzing the movement and structure of an object of claim 26 wherein said means for locating an exact center of said object comprises:
placing a plurality of increasingly smaller concentric geometrical images within said at least one cube.

29. A method for analyzing the movement and structure of an object comprising:
a. displaying an object having at least one indicator point on a display;
b. creating a geometrical grid having at least one cube;
c. superimposing said geometrical grid over at least one portion of said object wherein said object is substantially centered within said at least one cube;and
d. measuring and comparing the placement of said object within said grid to predetermined ideal positions.

30. The method of claim 29 wherein:
said display is a computer monitor.

31. The method of claim 29 wherein:
said geometrical grid is created with a computer.

32. The method of claim 29 further comprising a step after step b of:
rotating said at least one cube approximately thirty degrees in relation to said object.

33. The method of claim 29 further comprising a step after step c of:
saving measurements and comparisons of said object within said geometric grid to a database for comparison to future measurements of said object within said geometric grid.

34. The method of claim 33 further comprising a step of:
comparing said measurements of said object within said geometric grid to previous measurements of said object within said geometric grid.

35. The method of claim 34 further comprising a step of:
using said measurements and comparisons to previous measurements to diagnose and analyze weaknesses and strengths in said object's movement and structure.

36. A geometrical grid comprising:
at least one cube having at least one reference point located thereon.

37. The geometrical grid of claim 36 wherein:
said at least one cube is rotated approximately thirty degrees.

38. The geometrical grid of claim 36 further comprising:
at least one reference line intersecting with said at least one reference point and/or at least one face of said at least one cube.

39. The geometrical grid of claim 36 further comprising:
at least one reference circle superimposed over said at least one cube.

40. The geometrical grid of claim 36 further comprising:
at least one reference triangle superimposed over said at least one cube.
